(19) United States
(12) Patent Application Publication
(10) Pub. No.: US 2025/0377856 A1
(43) Pub. Date: Dec. 11, 2025

(54) AUDIO PLAYLIST GENERATION

(71) Applicant: BOSE CORPORATION, Framingham, MA (US)

(72) Inventors: Thomas David CHAMBERS, Bellingham, MA (US); Zachary David PROVOST, Marlborough, MA (US); Todd Richard REILY, North Reading, MA (US); Lauren Taylor WESTENDORF, Waltham, MA (US)

(21) Appl. No.: 19/218,115

(22) Filed: May 23, 2025

Related U.S. Application Data
(60) Provisional application No. 63/657,653, filed on Jun. 7, 2024.

(51) Int. Cl. G06F 3/16; G06F 16/638

(52) U.S. Cl. CPC G06F 3/165; G06F 16/639

(57) ABSTRACT

Techniques, including devices and systems implementing the techniques, for generating one or more audio playlists. One example system generally includes a device of a user, and one or more processors coupled to the device. The one or more processors, individually or collectively, are generally configured to: select, in response to an initial action of the user, at least one audio mode, and generate, for output on a speaker, one or more audio playlists based, at least in part, on at least one of a context of the device or one or more controls associated with the audio mode.

### CROSS-REFERENCE TO RELATED APPLICATION

This application claims priority to and benefit of U.S. Provisional Patent Application No. 63/657,653, filed June 7, 2024, the contents of which are herein incorporated by reference in its entirety as fully set forth below.

### FIELD

Aspects of the disclosure generally relate to devices, and, more particularly to techniques and audio devices for generating one or more audio playlists.

### BACKGROUND

Audio devices, such as speakers and wearable devices, are often utilized to enjoy various forms of entertainment. In some cases, audio devices may be used to enable users to listen to audio playlists. The audio playlists may each include, for example, a plurality of songs. Accordingly, methods for generating one or more audio playlist, as well as apparatuses and systems configured to implement these methods, are desired.

### SUMMARY

All examples and features mentioned herein can be combined in any technically possible manner.

Aspects of the present disclosure provide a system. The system includes a device of a user; and one or more processors coupled to the device. The one or more processors, individually or collectively, are configured to: select, in response to an initial action of the user, at least one audio mode; and generate, for output on a speaker, one or more audio playlists based, at least in part, on at least one of a context of the device or one or more controls associated with the audio mode.

In aspects, the one or more processors, individually or collectively, are configured to generate the one or more audio playlists by using a trained machine-learning model to generate at least one of a name for each of the one or more audio playlists or a seed song for each of the one or more audio playlists based, at least in part, on the context.

In aspects, the context includes at least one of a current time, a current day, an identity of the user, a schedule of the user, one or more favorite songs of the user, a listening history of the user, weather information, holiday information, or a connection of the device.

In aspects, the audio mode includes an attribute mode, where the one or more controls include one or more attribute controls associated with the attribute mode, and where when the attribute mode is selected, the one or more processors, individually or collectively, are further configured to generate the one or more audio playlists based, at least in part, on the one or more attribute controls.

In aspects, the one or more attribute controls are each configured to be manipulated by the user to select an attribute and control a magnitude corresponding to the attribute, and where the attribute includes an acousticness level, a danceability level, an energy level, an instrumentalness level, a liveness level, a speechiness level, a valence level, or a popularity level.

In aspects, the audio mode includes a curated mode, and where when the curated mode is selected, the one or more processors, individually or collectively, are configured to generate the one or more audio playlists by using the name for each of the one or more audio playlists to search for a related audio playlist previously created by the user or provided by a music library.

In aspects, the audio mode includes a background/foreground mode, where the one or more controls include a spectrum control associated with the background/foreground mode that ranges from a fully ambient level to a fully active level, and where when the background/foreground mode is selected, the one or more processors, individually or collectively, are further configured to generate the one or more audio playlists based, at least in part, on a level of the spectrum control.

In aspects, the audio mode includes an adventurous/familiar mode, where the one or more controls include a spectrum control associated with the adventurous/familiar mode that ranges from fully popular to fully user preferred, and where when the adventurous/familiar mode is selected, the one or more processors, individually or collectively, are further configured to generate the one or more audio playlists based, at least in part, on a level of the spectrum control.

In aspects, the audio mode includes a current mode, and where when the current mode is selected, the one or more processors, individually or collectively, are configured to generate the one or more audio playlists based, at least in part, on at least one of a current song or a current artist of the current song of an audio playlist of the one or more audio playlists being output from the speaker.

In aspects, the one or more processors, individually or collectively, are further configured to: output, on the speaker, one of the one or more audio playlists; and select the audio playlist of the one or more audio playlists output on the speaker based, at least in part, on one or more subsequent actions of the user, and where the one or more subsequent actions of the user include at least one of a speech vocalization of the user or a physical action of the user on the device.

In aspects, at least one of the one or more controls associated with the audio mode are at least periodically updated based, at least in part, on the context.

In aspects, the one or more processors, individually or collectively, are further configured to determine an identity of the user using a sensor during the initial action, and where the context is based, at least in part, on the identity of the user.

In aspects, the device includes a speaker system and the speaker is included in the speaker system; or the speaker is included in a wearable device configured to be controlled by the one or more processors.

In aspects, the initial action of the user includes at least one of a speech vocalization of the user or a physical action of the user on the device, and where the one or more processors, individually or collectively, are configured to select, in response to the initial action of the user, the audio mode by using a trained machine learning model to determine an intent of the user from the at least one of the speech vocalization of the user or the physical action of the user on the device.

Aspects of the present disclosure are directed to a method. The method includes selecting, in response to an initial action of a user of a device, at least one audio mode; and generating, for output on a speaker, one or more audio playlists based, at least in part, on at least one of a context of the device or one or more controls associated with the audio mode.

In aspects, generating the one or more audio playlists includes using a trained machine- learning model to generate at least one of a name for each of the one or more audio playlists or a seed song for each of the one or more audio playlists based, at least in part, on the context.

In aspects, the audio mode includes an attribute mode, where the one or more controls include one or more attribute controls associated with the attribute mode, and where when the attribute mode is selected, the one or more audio playlists are based, at least in part, on the one or more attribute controls.

Aspects of the present disclosure provide a non-transitory computer-readable medium including computer-executable instructions that, when executed by one or more processors of a device, cause the device to perform a method, the method including: selecting, in response to an initial action of a user of the device, at least one audio mode; and generating, for output on a speaker, one or more audio playlists based, at least in part, on at least one of a context of the device or one or more controls associated with the audio mode.

In aspects, generating the one or more audio playlists includes using a trained machine- learning model to generate at least one of a name for each of the one or more audio playlists or a seed song for each of the one or more audio playlists based, at least in part, on the context.

In aspects, the audio mode includes an attribute mode, where the one or more controls include one or more attribute controls associated with the attribute mode, and where when the attribute mode is selected, the one or more audio playlists are based, at least in part, on the one or more attribute controls.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2 illustrates another example system, in which aspects of the present disclosure may be implemented.

FIG. 3A illustrates an exemplary sound processing and playback device, in which aspects of the present disclosure may be implemented.

FIG. 3B illustrates an exemplary source device, in which aspects of the present disclosure may be implemented.

FIG. 4 illustrates example operations for audio playlist generation, in accordance with certain aspects of the present disclosure.

FIG. 5 illustrates an example summary of different audio modes that may be selected during the operations of FIG. 4, in accordance with certain aspects of the present disclosure.

FIG. 6 illustrates an example user interface, in accordance with certain aspects of the present disclosure.

### DETAILED DESCRIPTION

Certain aspects of the present disclosure provide techniques, including devices and systems implementing the techniques, for generating (e.g., curating) one or more audio playlists. Such techniques may involve selecting, in response to an initial action of a user of a device, an audio mode from a plurality of audio modes, and generating, for output on a speaker, one or more audio playlists based, at least in part, on at least one of a context of the device or one or more controls associated with the selected audio mode. The initial action of the user may include at least one of a speech vocalization of the user or a physical action of the user on the device (e.g., manipulation of an actuatable control feature on the device, such as a button or dial, or an affordance on the device). For example, the initial action of the user may include a speech vocalization of a user (e.g., asking the device to begin playing a playlist) and a physical action of the user on a device (e.g., touching a button or touching and holding a button). In another example, the initial action of the user may be a single physical touch of the user. The device may be implemented as a speaker system and a speaker may be included in the speaker system, or the speaker may be included in a separate wearable device configured to be controlled by the device. One of the one or more generated audio playlists may be output on the speaker, and the user may cycle through the audio playlists output on the speaker based, at least in part, on one or more subsequent actions of the user (e.g., which may include at least one of a speech vocalization of the user or a physical action of the user on the device).

In some cases, generating the one or more audio playlists may include using a trained machine learning model to generate at least one of a name for each of the one or more audio playlists or a seed song for each of the one or more audio playlists based, at least in part, on the context. The context may include at least one of a current time, a current day, an identity of the user, a schedule of the user, one or more favorite songs of the user, a listening history of the user, weather information, holiday information, or a connection of the device. The name for each of the one or more audio playlists and/or the seed song for each of the one or more audio playlists may serve as playlist architectures or archetypes and may be used in a search algorithm and/or a recommendation algorithm of a music library (e.g., Spotify, Apple Music, Amazon Music, and the like) to generate the one or more audio playlists. In these cases, the initial action of the user may select the audio mode, generate the one or more audio playlists based, at least in part, on the context of the device, and output one of the generated audio playlists on the speaker.

Many devices may struggle to determine what audio playlists a user wants to listen to, and as a result, have difficulty generating desirable audio playlists for a user without a great deal of interaction and guidance from the user. The present disclosure may enable a device to generate one or more audio playlists with minimal interaction and information from a user. For example, the audio mode may be selected and the one or more audio playlists may be generated based on the context of the device and output on a speaker in response to the initial action of the user. In addition, the present disclosure may also enable the user of the device to customize and/or personalize the generated one or more audio playlists based on the one or more subsequent actions of the user and/or the context of the device. The user of the device may also be able to select which of the one or more generated audio playlists is output to the speaker.

### An Example System

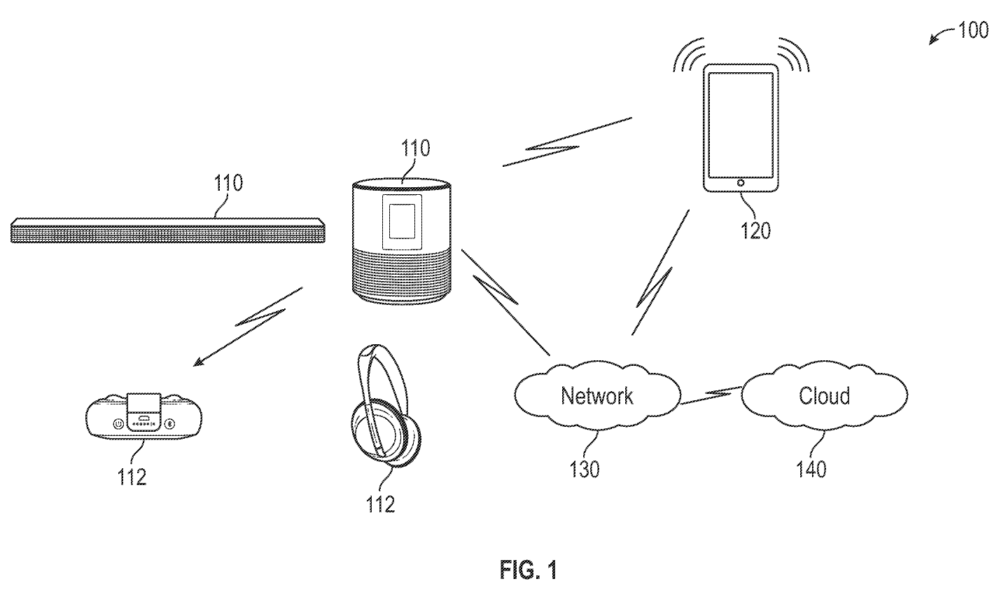

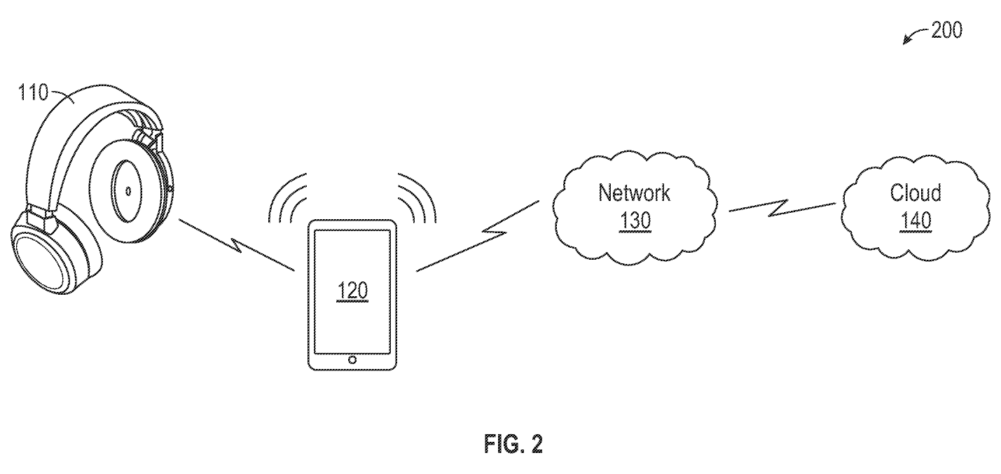

FIG. 1 illustrates an example system 100, in which aspects of the present disclosure may be implemented. As shown, system 100 includes one or more sound processing and playback devices 110 (e.g., a wireless audio device, such as a sound bar, a speaker, a smart speaker, a wearable device, or the like, as shown in FIG. 2) communicatively coupled with a source device 120 (e.g., a computing device or user device, such as a smartphone, tablet computer, television, smart device, or the like). Throughout the present disclosure, the sound processing and playback device 110 may be referred to simply as the device 110. In the example of FIG. 1, the device 110 is shown implemented as both a sound bar and a smart speaker. One or more partner devices 112 (e.g., a portable speaker, a headset, or the like) may be available to accept pairing requests from the device 110 or the source device 120. The device 110 may be paired with the source device 120 and may receive content data (including audio signal(s)) from the source device 120. The device 110 may also receive content data directly from the network 130. The partner device 112 may be battery-powered portable devices suitable for mobile or privacy applications.

The device 110 may include hardware and circuitry including processor(s)/processing system and memory configured to implement one or more sound management capabilities or other capabilities including, but not limited to, noise cancelling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the device 110 by using active noise cancelling (also known as active noise reduction). The sound masking circuitry is configured to reduce distractions by playing masking sounds via the speakers of the device 110. The movement detecting circuitry is configured to use devices/sensors such as an accelerometer, gyroscope, magnetometer, or the like to detect whether the user wearing the device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in augmented reality (AR) applications where an AR sound is played back based on a direction of gaze of the user.

In certain aspects, the device 110 may be wirelessly connected to the source device 120 or the partner devices 112 using one or more wireless communication methods including, but not limited to, Bluetooth, Wi-Fi, Bluetooth Low Energy (BLE), other radio frequency (RF) based techniques, or the like. In certain aspects, the device 110 includes a transceiver that transmits and receives data via one or more antennae in order to exchange audio data and other information with the source device 120.

In certain aspects, the device 110 includes communication circuitry capable of transmitting and receiving audio data and other information from the source device 120. The device 110 also includes an incoming audio buffer, such as a render buffer, that buffers at least a portion of an incoming audio signal (e.g., audio packets) in order to allow time for retransmissions of any missed or dropped data packets from the source device 120. For example, when the device 110 receives Bluetooth transmissions from the source device 120, the communication circuitry typically buffers at least a portion of the incoming audio data in the render buffer before the audio is actually rendered and output as audio to at least one of the transducers (e.g., audio speakers) of the device 110. This is done to ensure that even if there are RF collisions that cause audio packets to be lost during transmission, that there is time for the lost audio packets to be retransmitted by the source device 120 before they have to be rendered by the device 110 for output by one or more acoustic transducers of the device 110.

One example of the partner device 112 is shown as noise-canceling headphones; however, the techniques described herein apply to other wireless audio devices, such as wearable audio devices, including any audio output device that fits around, on, in, or near an ear (including open-ear audio devices worn on the head or shoulders of a user) or other body parts of a user, such as head or neck. The partner device 112 may take any form, wearable or otherwise, including standalone alone devices (including automobile speaker system), stationary devices (including portable devices, such as battery powered portable speakers), headphones, earphones, earpieces, headsets, goggles, headbands, earbuds, armbands, sport headphones, neckband, hearing aids, or eyeglasses with integrated speaker(s).

In certain aspects, the device 110 is connected to the source device 120 using a wired connection, with or without a corresponding wireless connection. The source device 120 can be a smartphone, a tablet computer, a laptop computer, a digital camera, or other user device that connects with the device 110. As shown, the source device 120 can be connected to a network 130 (e.g., the Internet) and can access one or more services over the network. As shown, these services can include one or more cloud 140 services.

In certain aspects, the source device 120 can access a cloud server in the cloud 140 over the network 130 using a mobile web browser or a local software application or "app" executed on the source device 120. In certain aspects, the software application or "app" is a local application that is installed and runs locally on the source device 120. In certain aspects, a cloud server accessible on the cloud 140 includes one or more cloud applications that are run on the cloud server. The cloud application can be accessed and run by the source device 120. For example, the cloud application can generate web pages that are rendered by the mobile web browser on the source device 120. In certain aspects, a mobile software application installed on the source device 120 or a cloud application installed on a cloud server, individually or in combination, may be used to implement the techniques for low latency Bluetooth communication between the source device 120 and the device 110 in accordance with aspects of the present disclosure. In certain aspects, examples of the local software application and the cloud application include a gaming application, an audio AR application, and/or a gaming application with audio AR capabilities. The source device 120 may receive signals (e.g., data and controls) from the device 110 and send signals to the device 110.

FIG. 2 illustrates another example system 200, in which aspects of the present disclosure may be implemented. In the example of FIG. 2, the sound processing and playback device 110 is shown implemented as a wearable device configured to be worn by a user, and may be a headset that includes two or more speakers, as illustrated in FIG. 2. At a high level, the device 110 may play audio content transmitted from the source device 120. The user may use the graphical user interface (GUI) on the source device 120 to select the audio content and/or adjust settings of the device 110. The device 110 provides soundproofing, active noise cancellation, and/or other audio enhancement features to play the audio content transmitted from the source device 120.

The device 110 is illustrated in FIG. 2 as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, or eyeglasses.

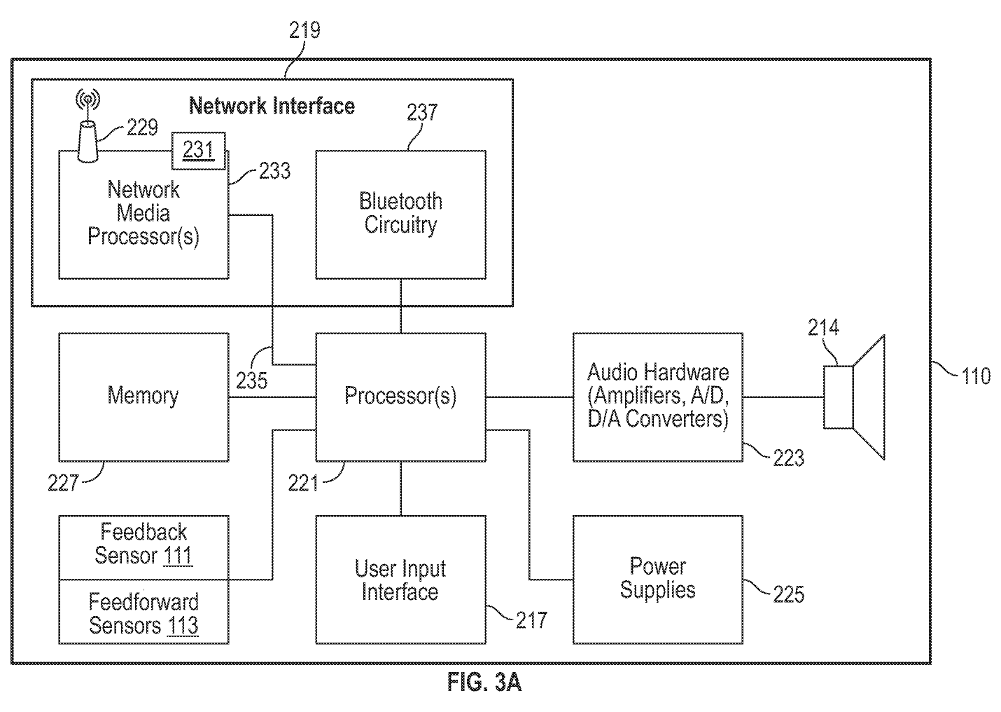

FIG. 3A illustrates an exemplary device 110 and some of its components. Other components may be inherent in the device 110 and not shown in FIG. 3A. For example, the device 110 may include an enclosure that houses an optional graphical interface (e.g., an organic light- emitting diode (OLED) display) which can provide the user with information regarding currently playing ("Now Playing") music. In certain aspects, the partner device 112 may include components illustrated in FIG. 3A and described above.

The device 110 may include one or more electro-acoustic transducers (e.g., an acoustic driver or speaker) 214 for outputting audio. The device 110 may also include a user input interface 217. The user input interface 217 may include a plurality of preset indicators, which may be hardware buttons. The preset indicators may provide the user with easy, one press access to entities assigned to those buttons. The assigned entities may be associated with different ones of the digital audio sources such that a single device 110 may provide for single press access to various different digital audio sources.

The device 110 may include a feedback sensor 111 and feedforward sensor(s) 113. The feedback sensor 111 and the feedforward sensor(s) 113 may include two or more microphones for capturing ambient sound and provide audio signals for determining location attributes of events. The transmission delays may be used to reduce errors in subsequent computation. The feedforward sensor(s) 113 may provide two or more channels of audio signals. The audio signals are captured by microphones that are spaced apart and may have different directional responses. The two or more channels of audio signals may be used for calculating directional attributes of an event of interest.

As shown in FIG. 3A, the the device 110 may include one or more electro-acoustic transducers (e.g., an acoustic driver or speaker) 214 to transduce audio signals to acoustic energy through audio hardware 223. The the device 110 also may include a network interface 219, at least one processor 221, the audio hardware 223, power supplies 225 for powering the various components of the the device 110, and memory 227. In certain aspects, the processor(s) 221, the network interface 219, the audio hardware 223, the power supplies 225, and the memory 227 are interconnected using various buses 235, and several of the components can be mounted on a common motherboard or in other manners as appropriate. In some cases, the at least one processor(s) 221 may be included in a controller.

The network interface 219 provides for communication between the the device 110 and other electronic computing devices via one or more communications protocols, such as Bluetooth classic protocol, Bluetooth low energy protocol, and others. The network interface 219 provides either or both of a wireless network interface 229 and a wired interface 231. The wireless network interface 229 allows the the device 110 to communicate wirelessly with other devices in accordance with a wireless communication protocol such as IEEE 802.11. The wired interface 231 provides network interface functions via a wired (e.g., Ethernet) connection for reliability and fast transfer rate, for example, used when the the device 110 is not worn by a user. Although illustrated, the wired interface 231 is optional.

In certain aspects, the network interface 219 includes at least one network media processor 233 for supporting Apple AirPlay® and/or Apple Airplay® 2. For example, if a user connects an AirPlay® or Apple Airplay® 2 enabled device, such as an iPhone or iPad device, to the network, the user can then stream music to the network connected audio playback devices via Apple AirPlay® or Apple Airplay® 2. Notably, the audio playback device can support audio- streaming via AirPlay®, Apple Airplay® 2 and/or Digital Living Network Alliance's (DLNA) Universal Plug and Play (UPnP) protocols, all integrated within one device.

All other digital audio received as part of network packets may pass straight from the network media processor 233 through a universal serial bus (USB) bridge (not shown) to the processor(s) 221 and runs into the decoders, DSP, and eventually is played back (rendered) via the electro-acoustic transducer(s) 214.

The network interface 219 can further include Bluetooth circuitry 237 for Bluetooth applications (e.g., for wireless communication with a Bluetooth enabled audio source such as a smartphone or tablet) or other Bluetooth enabled speaker packages. In certain aspects, the Bluetooth circuitry 237 may be the primary network interface 219 due to energy constraints. For example, the network interface 219 may use the Bluetooth circuitry 237 solely for mobile applications when the wearable device 210 adopts any wearable form. For example, BLE technologies may be used in the wearable device 210 to extend battery life, reduce package weight, and provide high quality performance without other backup or alternative network interfaces.

In certain aspects, the network interface 219 supports communication with other devices using multiple communication protocols simultaneously at one time. For instance, the the device 110 can support Wi-Fi/Bluetooth coexistence and can support simultaneous communication using both Wi-Fi and Bluetooth protocols at one time. For example, the the device 110 can receive an audio stream from a smart phone using Bluetooth and can further simultaneously redistribute the audio stream to one or more other devices over Wi-Fi. In certain aspects, the network interface 219 may include only one RF chain capable of communicating using only one communication method (e.g., Wi-Fi or Bluetooth) at one time. In this context, the network interface 219 may simultaneously support Wi-Fi and Bluetooth communications by time sharing the single RF chain between Wi-Fi and Bluetooth, for example, according to a time division multiplexing (TDM) pattern.

Streamed data may pass from the network interface 219 to the processor(s) 221. The processor(s) 221 may execute instructions (e.g., for performing, among other things, digital signal processing, decoding, and equalization functions), including instructions stored in the memory 227. The processor(s) 221 may be implemented as a chipset of chips that includes separate and multiple analog and digital processors. The processor(s) 221 may provide, for example, for coordination of other components of the the device 110, such as control of user interfaces.

The memory 227 may store software/firmware related to protocols and versions thereof used by the device 110 for communicating with other networked devices, including the source device 120. For example, the software/firmware governs how the device 110 communicates with other devices for synchronized playback of audio. In certain aspects, the software/firmware includes lower level frame protocols related to control path management and audio path management. The protocols related to control path management generally include protocols used for exchanging messages between speakers. The protocols related to audio path management generally include protocols used for clock synchronization, audio distribution/frame synchronization, audio decoder/time alignment, and playback of an audio stream. In certain aspects, the memory can also store various codecs supported by the speaker package for audio playback of respective media formats. In certain aspects, the software/firmware stored in the memory can be accessible and executable by the processor for synchronized playback of audio with other networked speaker packages.

In certain aspects, the protocols stored in the memory 227 may include BLE according to, for example, the Bluetooth Core Specification Version 5.2 (BT5.2). The the device 110 and the various components therein are provided herein to sufficiently comply with or perform aspects of the protocols and the associated specifications. For example, BT5.2 includes enhanced attribute protocol (EATT) that supports concurrent transactions. A new L2CAP mode is defined to support EATT. As such, the the device 110 may include hardware and software components sufficiently to support the specifications and modes of operations of BT5.2, even if not expressly illustrated or discussed in this disclosure. For example, the device 110 may utilize LE Isochronous Channels specified in BT5.2.

The processor(s) 221 provides a processed digital audio signal to the audio hardware 223 which includes one or more digital-to-analog (D/A) converters for converting the digital audio signal to an analog audio signal. The audio hardware 223 also includes one or more amplifiers which provide amplified analog audio signals to the electro-acoustic transducer(s) 214 for sound output. In addition, the audio hardware 223 may include circuitry for processing analog input signals to provide digital audio signals for sharing with other devices, for example, other speaker packages for synchronized output of the digital audio.

The memory 227 can include, for example, flash memory and/or non-volatile random- access memory (NVRAM). In certain aspects, instructions (e.g., software) are stored in an information carrier. The instructions, when executed by one or more processing devices (e.g., the processor(s) 221), perform one or more processes, such as those described elsewhere herein. The instructions can also be stored by one or more storage devices, such as one or more computer or machine-readable mediums (for example, the memory 227, or memory on the processor). The instructions can include instructions for performing decoding (i.e., the software modules include the audio codecs for decoding the digital audio streams), as well as digital signal processing and equalization. In certain aspects, the memory 227 and the processor(s) 221 may collaborate in data acquisition and real time processing with the feedback sensor 111 and feedforward sensor(s) 113.

FIG. 3B illustrates an exemplary source device 120, such as a smartphone or a mobile computing device, in accordance with certain aspects of the present disclosure. Some components of the source device 120 may be inherent and not shown in FIG. 3B. For example, the source device 120 may include an enclosure. The enclosure may house an optional graphical interface 212 (e.g., an OLED display), as shown. The graphical interface 212 provides the user with information regarding currently playing ("Now Playing") music or video. The source device 120 includes one or more electro-acoustic transducers 215 for outputting audio. The source device 120 may also include a user input interface 216 that enables user input.

The source device 120 also includes a network interface 220, at least one processor 222, audio hardware 224, power supplies 226 for powering the various components of the source device 120, and a memory 228. In certain aspects, the processor(s) 222, the graphical interface 212, the network interface 220, the audio hardware 224, the one or more power supplies 226, and the memory 228 are interconnected using the one or more buses 236, and several of the components can be mounted on a common motherboard or in other manners as appropriate. In certain aspects, the processor(s) 222 of the source device 120 is more powerful in terms of computation capacity than the processor(s) 221 of the the device 110. Such difference may be due to constraints of weight, power supplies, and other requirements. Similarly, the power supplies 226 of the source device 120 may be of a greater capacity and heavier than the power supplies 225 of the the device 110. In some cases, the at least one processor(s) 222 may be included in a controller.

The network interface 220 provides for communication between the source device 120 and the device 110, as well as other audio sources and other wireless speaker packages including one or more networked wireless speaker packages and other audio playback devices via one or more communications protocols. The network interface 220 can provide either or both of a wireless network interface 230 and a wired interface 232. The wireless network interface 230 allows the source device 120 to communicate wirelessly with other devices in accordance with a wireless communication protocol, such as IEEE 802.11. The wired interface 232 provides network interface functions via a wired (e.g., Ethernet) connection.

In certain aspects, the network interface 220 may also include at least one network media processor 234 and Bluetooth circuitry 238, similar to the network media processor 233 and Bluetooth circuitry 237 in the device 110 in FIG. 3A. Further, in aspects, the network interface 220 supports communication with other devices using multiple communication protocols simultaneously at one time, as described with respect to the network interface 219 in FIG. 3A.

All other digital audio received as part of network packets comes straight from the network media processor 234 through one or more buses 236 (e.g., USB bridge) to the processor 222 and runs into the decoders, DSP, and eventually is played back (rendered) via the electro- acoustic transducer(s) 215.

The source device 120 may also include an image or video acquisition unit 280 for capturing image or video data. For example, the image or video acquisition unit 280 may be connected to one or more cameras 282 and capable of capturing still or motion images. The image or video acquisition unit 280 may operate at various resolutions or frame rates according to a user selection. For example, the image or video acquisition unit 280 may capture 4K videos (e.g., a resolution of 3840 by 2160 pixels) with the one or more cameras 282 at 30 frames per second, full high definition (FHD) videos (e.g., a resolution of 1920 by 1080 pixels) at 60 frames per second, or a slow motion video at a lower resolution, depending on hardware capabilities of the one or more cameras 282 and the user input. The one or more cameras 282 may include two or more individual camera units having respective lenses of different properties, such as focal length resulting in different fields of views. The image or video acquisition unit 280 may switch between the two or more individual camera units of the cameras 282 during a continuous recording.

Captured audio or audio recordings, such as the voice recording captured at the device 110, may pass from the network interface 220 to the processor(s) 222. The processor(s) 222 executes instructions within the wireless speaker package (e.g., for performing, among other things, digital signal processing, decoding, and equalization functions), including instructions stored in the memory 228. The processor(s) 222 can be implemented as a chipset of chips that includes separate and multiple analog and digital processors. The processor(s) 222 can provide, for example, for coordination of other components of the audio source device 120, such as control of user interfaces and applications. The processor(s) 222 provides a processed digital audio signal to the audio hardware 224 similar to the respective operation by the processor(s) 221 described in FIG. 3A.

The memory 228 can include, for example, flash memory and/or NVRAM. In certain aspects, instructions (e.g., software) are stored in an information carrier. The instructions, when executed by one or more processing devices (e.g., the processor(s) 222), perform one or more processes, such as those described herein. The instructions can also be stored by one or more storage devices, such as one or more computer or machine-readable mediums (for example, the memory 228, or memory on the processor(s) 222). The instructions can include instructions for performing decoding (i.e., the software modules include the audio codecs for decoding the digital audio streams), as well as digital signal processing and equalization.

### Example Operations for Audio Playlist Generation

Certain aspects of the present disclosure provide techniques, including devices and systems implementing the techniques, for generating one or more audio playlists. Such techniques may involve selecting, in response to an initial action of a user of a device, an audio mode from a plurality of audio modes, and generating, for output on a speaker, one or more audio playlists based, at least in part, on at least one of a context of the environment of the device or one or more controls associated with the audio mode. In some cases, generating the one or more audio playlists may include using a trained machine learning model to generate at least one of a name for each of the one or more audio playlists or a seed song for each of the one or more audio playlists based, at least in part, on the context. As a result, a device may generate one or more audio playlists with minimal interaction and information from a user. In addition, the user of the device may be able to customize and/or personalize the one or more generated audio playlists based, at least in part, on the one or more subsequent actions of the user and/or the context of the device. The user of the device may also be able to select which of the one or more generated audio playlists is output to the speaker.

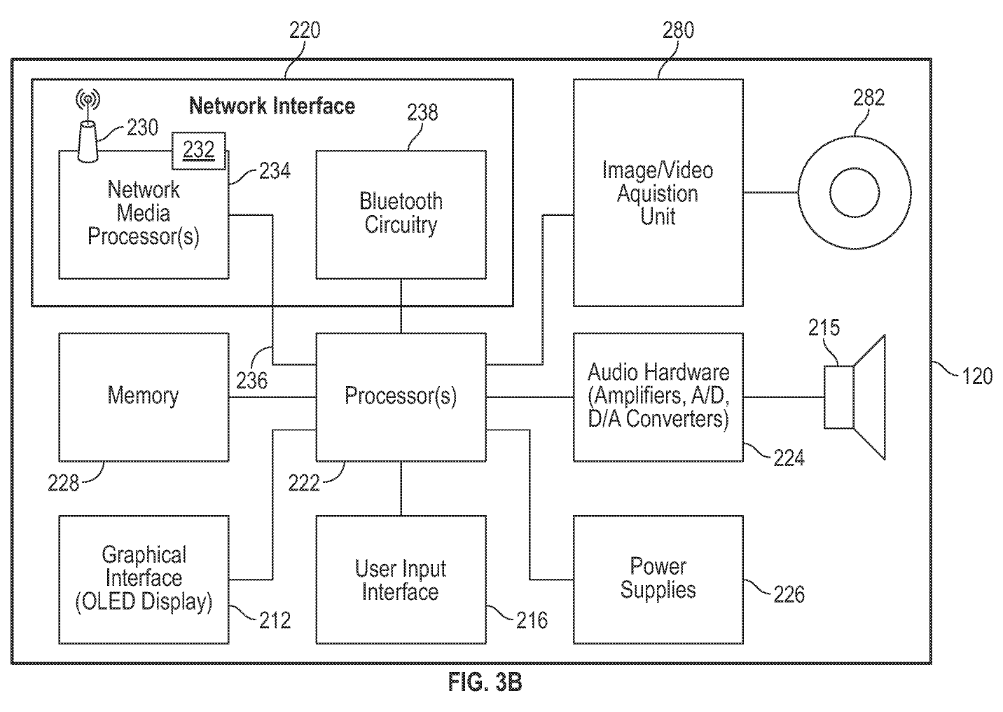

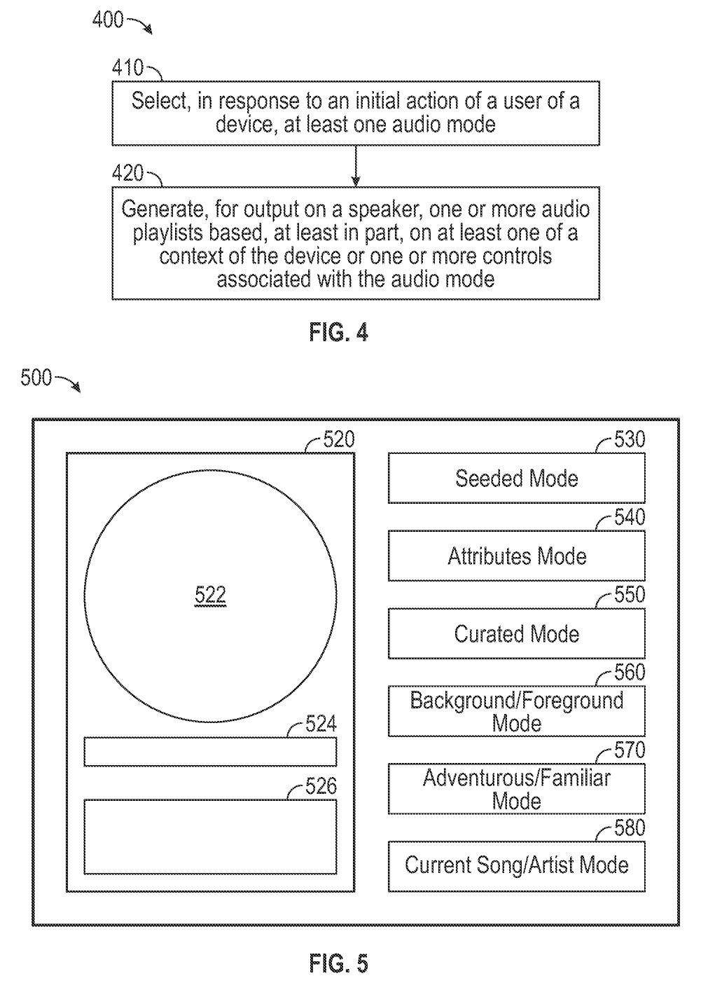

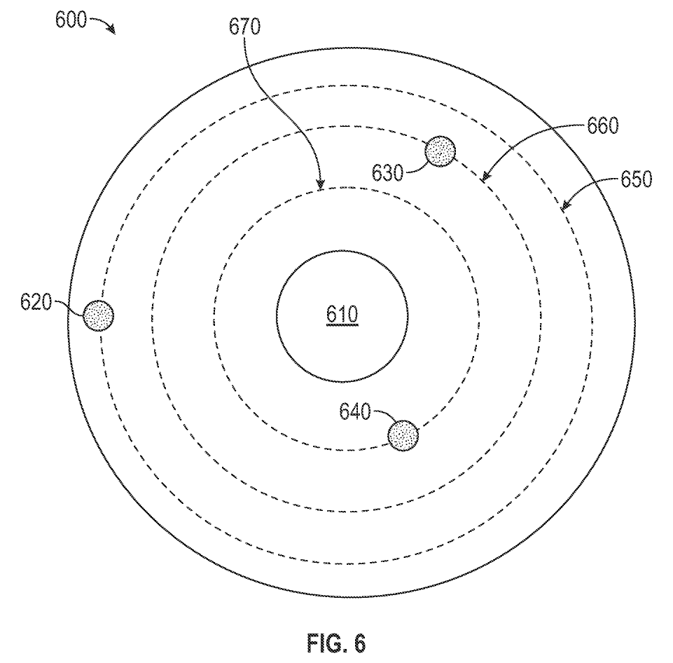

FIG. 4 illustrates example operations 400 for audio playlist generation, in accordance with certain aspects of the present disclosure. FIG. 5 illustrates an example summary 500 of different audio modes that may be selected during the operations of FIG. 4, in accordance with certain aspects of the present disclosure. FIG. 6 illustrates an example user interface 600, in accordance with certain aspects of the present disclosure. Therefore, FIGS. 4, 5, and 6 are herein described together for clarity. The operations 400 may be performed by a device (e.g., an audio device, such as the device 110 of FIG. 1 and FIG. 2, which may be implemented as, for example, a sound bar, a speaker, or a smart speaker, a wearable device, or the like) or an accessory device (e.g., a source device 120, which may be implemented as, for example, a smartphone, tablet computer, television, smart device, or the like). The device may be or include the user interface 600. For example, the operations 400 may be performed by the at least one processor(s) 221 included in the device 110 implemented as a speaker system (e.g., as illustrated in FIG. 1) or as a wearable device (e.g., as illustrated in FIG. 2). In this example, the speaker may be implemented in the device. In another example, the operations 400 may be performed by the at least one processor(s) 222 included in the source device 120 (e.g., as illustrated in FIG. 1). In this example, the speaker may be implemented in a different device (e.g., a speaker system) that is in communication with and configured to be controlled by the source device 120. When multiple processor(s) 221 or processor(s) 222, the multiple processor(s) 221 or the multiple processor(s) 222 may perform the operations 400 individually or collectively.

The operations 400 may include, at block 410, selecting, in response to an initial action of the user, an audio mode. The audio modes that may be selected may include one or more of a Seeded mode 530, an Attribute mode 540, a Curated Mode 550, a Background/Foreground mode 560, an Adventurous/Familiar mode 570, or a Current Song/Artist mode 580. In certain aspects, selecting the audio mode at block 410 may include selecting a single audio mode. In other aspects, selecting the audio mode at block 410 may include simultaneously selecting more than one audio mode. In this manner, multiple audio modes may be used in conjunction to generate the one or more audio playlists at block 420, which is described below. Although six modes are illustrated in the summary 500 of FIG. 5, any number or combination of the Seeded mode 530, the Attribute mode 540, the Curated Mode 550, the Background/Foreground mode 560, the Adventurous/Familiar mode 570, and the Current Song/Artist mode 580 may be available for selection during the operations 400.

In certain aspects, the initial action of the user may include at least one of a speech vocalization of the user or a physical action of the user on the device. The selecting of the audio mode at block 410 may include using a trained machine learning model to determine an intent of the user from the at least one of the speech vocalization of the user or the physical action of the user on the device. In some cases, the initial action of the user may include a speech vocalization of the user, and the speech vocalization may be natural and conversational, making the intent of the user not easily apparent. In these cases, the trained machine learning model may be used to determine the intent of the user from the speech vocalization (e.g., using past interactions with the user). For example, when the speech vocalization of the user does not clearly select one or more of the audio modes at block 410, the trained machine learning model may be able to determine which audio mode(s) to select based on the history of the user and/or the context of the device. The trained machine learning models referred to herein may be the same trained machine learning model, or in some cases, different trained machine learning models.

At block 420, the operations 400 may include generating, for output on a speaker (e.g., electro-acoustic transducer(s) 214 included in device 110 and/or electro-acoustic transducer(s) 215 included in source device 120), one or more audio playlists based, at least in part, on at least one of a context of the device or one or more controls associated with the audio mode. Any number of audio playlists may be generated at block 420. In some cases, six audio playlists may be generated. The number of audio playlists generated may be manipulated (e.g., controlled) by the user of the device (e.g., using voice or physical touch). In certain aspects, the device may include or be implemented as a speaker system, and the speaker may be included in the speaker system. In other aspects, the speaker may be included in a separate wearable device configured to be controlled by one or more processors included in the device.

In certain aspects, the one or more controls associated with the audio mode may be implemented with any combination of actuatable control features, such as sliders, buttons, knobs, or other similar controls. In these aspects, the physical action of the user on the device may include manipulating the actuatable control features. In other aspects, the physical action may be the user hovering their hand over the device, and the physical action may be captured by a proximity sensor included in the device. In certain aspects, the user may be identified using a sensor (e.g., a fingerprint sensor that may be embedded in the device) during the initial action, and/or identified using voice recognition.

According to certain aspects, generating the one or more audio playlists at block 420 includes using a trained machine-learning model to generate at least one of a name for each of the one or more audio playlists or a seed song for each of the one or more audio playlists based on the context. The name for each of the one or more audio playlists and/or the seed song for each of the one or more audio playlists may be used in a search algorithm and/or a recommendation algorithm of a music library (e.g., Spotify, Apple Music, Amazon Music, and the like) to generate the one or more audio playlists. In some cases, more than one seed song may be generated by the trained machine-learning model for generating each of the one or more audio playlists. The name and/or the seed song (or seed songs) for each of the one or more audio playlists may be unique, such that each of the generated one or more audio playlists are different and each provides a unique playlist for the user to listen to.

In certain aspects, the audio mode selected may include the Seeded mode 530. In these aspects, the one or more audio playlists generated at block 420 using a trained machine-learning model to generate a seed song for each of the one or more audio playlists based on the context. The seed song for each of the one or more audio playlists may be used in a search algorithm and/or a recommendation algorithm of a music library (e.g., Spotify, Apple Music, Amazon Music, and the like) to generate the one or more audio playlists, each of the generated audio playlists being different (as a result of the different seed song used for each of the generated audio playlists). In this manner, the user of the device may have quick access to one or more generated audio playlists based on the context of the device.

The context of the device may include at least one of a current time, a current day, an identity of the user, a schedule of the user, one or more favorite songs of the user, a listening history of the user, weather information, holiday information, or a connection of the device. For example, when the device is connected (e.g., via Bluetooth or a universal series bus (USB) connection) to a vehicle (e.g., a car, truck, or the like), the one or more generated playlists at block 420 may be commuter-focused playlists (e.g., the trained machine-learning model may generate a commuter- focused name for each of the one or more generated audio playlists and/or a commuter-focused seed song for each of the one or more generated audio playlists to be used with the music library to generate the one or more audio playlists). In another example, when the device is connected (e.g., via Bluetooth or a USB connection) to multiple speakers (e.g., a large music system), the one or more generated playlists at block 420 may be party-focused playlists (e.g., the trained machine- learning model may generate a party-focused name for each of the one or more generated audio playlists and/or a party-focused seed song for each of the one or more generated audio playlists to be used with the music library to generate the one or more audio playlists). In aspects where the user of the device has been identified as described above, the context is based, at least in part, on the identity of the user. For example, when the user of the device has been identified, a schedule of the user, one or more favorite songs of the user, or a listening history of the user may be included in the context and may be specific to the user. In this manner, the one or more generated playlists at block 420 may be more personalized to the identified user of the device.

In a third example, the current time could be the afternoon, the current day could be Sunday, and the weather information could be sunny (e.g., the device may be located in a sunny environment), and the one or more generated playlists at block 420 may be sunny Sunday afternoon-focused playlists (e.g., the trained machine-learning model may generate a sunny Sunday afternoon-focused name for each of the one or more generated audio playlists and/or a sunny Sunday afternoon-focused seed song for each of the one or more generated audio playlists to be used with the music library to generate the one or more audio playlists). In a fourth example, the holiday information may include that a holiday (e.g., Christmas) is approaching, and the one or more generated playlists at block 420 may be Christmas-focused playlists (e.g., the trained machine-learning model may generate a Christmas-focused name for each of the one or more generated audio playlists and/or a Christmas-focused seed song for each of the one or more generated audio playlists to be used with the music library to generate the one or more audio playlists). These examples are merely illustrative, and it is to be understood that any number and combination of the context factors (e.g., the current time, the current day, the identity of the user, the schedule of the user, one or more favorite songs of the user, the listening history of the user, weather information, holiday information, or the connection of the device) may be used in the generation of the one or more audio playlists at block 420.

According to certain aspects, the audio mode selected may include the Attributes mode 540, the one or more controls may include one or more attribute controls associated with the Attributes mode 540, and when the Attributes mode 540 is selected, the one or more audio playlists generated at block 420 may be based, at least in part, on the one or more attribute controls. In certain aspects, the one or more attribute controls may be manipulated (e.g., controlled or tuned) by the user to select an attribute and control a magnitude (e.g., from 0.0 to 1.0) corresponding to the attribute. The attribute(s) that may be selected may include one or more of an acousticness level, a danceability level, an energy level, an instrumentalness level, a liveness level, a speechiness level, a valence level, or a popularity level (which may be defined and utilized by a music library as described herein). In some cases, when the Attributes mode 540 is selected, the trained machine-learning model may generate the seed song for each of the one or more generated audio playlists based on the context and on the one or more attribute controls. The seed song may then be used in the search algorithm and/or the recommendation algorithm of the music library as described above to generate the one or more audio playlists at block 420. For example, a danceability level, an energy level, an instrumentalness level may be utilized, and the seed song for each of the one or more generated audio playlists at block 420 may be based on the context and on the danceability level, the energy level, and the instrumentalness level.

According to certain aspects, the audio mode selected may include a Curated mode 550, and when the Curated mode 550 is selected, the one or more audio playlists may be generated at block 420 by using the name for each of the one or more audio playlists (e.g., the name(s) generated by the trained machine-learning model) to search for a related audio playlist previously created by the user or provided by a music library (e.g., Spotify, Apple Music, Amazon Music, and the like). For example, when a name of one of the one or more audio playlists is "sunny afternoon barbeque," the name may be used to search for sunny afternoon barbeque related audio playlists previously created by the user or provided by the music library to generate the one or more audio playlists at block 420. In another example, when a name of one of the one or more audio playlists is "dinner jazz," the name may be used to search for dinner jazz related audio playlists previously created by the user or provided by the music library to generate the one or more audio playlists at block 420.

According to certain aspects, the audio mode selected may include a Background/Foreground mode 560, the one or more controls include a spectrum control associated with the Background/Foreground mode 560 that ranges from a fully ambient level to a fully active level, and when the Background/Foreground mode 560 is selected, the one or more audio playlists generated at block 420 may be based, at least in part, on a level of the spectrum control. The spectrum control may be manipulated (e.g., controlled or tuned) by the user to select a magnitude (e.g., from 0.0 to 1.0) corresponding to the spectrum. For example, the user may want background music, and may manipulate the spectrum control to favor background music. In other examples, the user may want foreground (e.g., active) music, and may manipulate the spectrum control to favor foreground music. In some cases, when the Background/Foreground mode 560 is selected, the trained machine-learning model may generate the seed song for each of the one or more generated audio playlists based on the context and on the one or more attribute controls. The seed song may then be used in the search algorithm and/or the recommendation algorithm of the music library as described above to generate the one or more audio playlists at block 420. For example, the seed song for each of the one or more generated audio playlists may be based on the context and on the level of the spectrum control associated with the Background/Foreground mode 560.

According to certain aspects, the audio mode selected may include an Adventurous/Familiar mode 570, the one or more controls include a spectrum control associated with the Adventurous/Familiar mode 570 that ranges from fully popular to fully user preferred, and when the Adventurous/Familiar mode 570 is selected, the one or more audio playlists generated at block 420 may be based, at least in part, on a level of the spectrum control. The spectrum control may be manipulated (e.g., controlled or tuned) by the user to select a magnitude (e.g., from 0.0 to 1.0) corresponding to the spectrum. In some cases, when the Adventurous/Familiar mode 570 is selected, the trained machine-learning model may generate the seed song for each of the one or more generated audio playlists based on the context and on the one or more attribute controls. The seed song may then be used in the search algorithm and/or the recommendation algorithm of the music library as described above to generate the one or more audio playlists at block 420. For example, the seed song for each of the one or more generated audio playlists may be based on the context and on the level of the spectrum control associated with the Adventurous/Familiar mode 570.

According to certain aspects, the audio mode selected may include a Current Song/Artist mode 580 (also referred to as a current mode), and when the Current Song/Artist mode 580 is selected, the one or more audio playlists generated at block 420 may be based, at least in part, on at least one of a current song or a current artist of the current song of an audio playlist of the one or more audio playlists being output (e.g., played) from the speaker. In some cases, when the Current Song/Artist mode 580 is selected, the current song and/or current artist may be used in the search algorithm and/or the recommendation algorithm of the music library as described above to generate the one or more audio playlists at block 420 (without the use of the seed song generated using the trained machine learning model).

According to certain aspects, the operations 400 may include outputting (e.g., playing), on the speaker, one of the one or more audio playlists, and selecting the audio playlist of the one or more audio playlists output on the speaker based, at least in part, on one or more subsequent actions of the user. The one or more subsequent actions of the user may further customize and/or personalize the one or more generated audio playlists at block 420. For example, the one or more subsequent actions of the user may include a voice command from the user to play "country music for a vacation road trip" and/or or physical manipulation of a control (e.g., a control associated with the Curated mode 550), and the one or more generated audio playlists at block 420 may be adapted to be more closely associated with the voice command and/or the level of the control and less associated with the context of the device. The one or more subsequent actions of the user may also enable the user to select which of the one or more generated audio playlists at block 420 is output to the speaker. The one or more subsequent actions of the user may include at least one of a speech vocalization of the user or a physical action of the user on the device, and may be similar to the initial action of the user described above.

The at least one of the one or more controls associated with the audio mode may be at least periodically updated based, at least in part, on the context. For example, the updating of the one or more controls associated with the audio mode may be periodically updated based, at least in part, on the context or continually updated based, at least in part, on the context. The rate at which the one or more controls are changed may be controlled by the user and/or determined using a trained machine learning model. For example, when the Background/Foreground mode 560 is selected, the spectrum control associated with the Background/Foreground mode 560 may increase from the fully active level to the fully ambient level as the time of day becomes later. In another example, when the Adventurous/Familiar mode 570 is selected, the spectrum control associated with the Adventurous/Familiar mode 570 may increase from fully popular to fully user preferred as the current day changes and approaches the weekend. These examples are merely illustrative, and it is to be understood that any number and combination of the one or more controls associated with the audio mode may be updated based, at least in part, on the context of the device in any manner.

In certain aspects, the device may already be outputting a song of an audio playlist to the speaker (e.g., using one or more audio playlists generated using the Curated Mode 550) when the audio mode is selected at block 410. In other aspects, the device may not be outputting a song of an audio playlist to the speaker, and when the audio mode is selected at block 410, the speaker may output the one or more audio playlists at block 420 to the speaker.

In certain aspects, the summary 500 of FIG. 5 may be visually displayed on a display of a device (e.g., a cellphone or tablet). The summary 500 may include a listing of the available audio modes (e.g., Seeded mode 530, Attribute mode 540, Curated Mode 550, Background/Foreground mode 560, Adventurous/Familiar mode 570, and/or Current Song/Artist mode 580). The summary 500 may also include an image 520. The image 520 may include a representation 522 of the song being output at the speaker, information 524 about the song being output (e.g., the time index of the song and/or the name of the song), and one or more controls 526 (e.g., controls including a play button, a pause button, a next song button, a previous song button, and/or an add to music library button).

The user interface 600 of FIG. 6 may be displayed on the device, and may include a display 610 that illustrates the selected audio mode(s) and/or one or more controls associated with the selected audio mode(s). For example, the display 610 may illustrate a novelty level (e.g., the level of novelty of the songs in the generated playlist), an energy level (e.g., the level of energy of the songs in the generated playlist), and a lyricism level (e.g., the amount of lyrics in the songs in the generated playlist), and the current selected state of each level (e.g., low, medium, or high).

The user interface 600 may also include controls 620, 630, and 640. The controls 620, 630, and 640 are shown in FIG. 6 implemented as dials, but any of the controls 620, 630, and 640 may be implemented as slides, buttons, knobs, or other similar controls. Although three controls are illustrated, any number of controls may be used in the user interface 600. The controls 620, 630, and 640 may be manipulated by twisted (e.g., turned while stationary) the controls 620, 630, and 640, and/or by rotating the controls 620, 630, and 640 along tracks 650, 660, and 670, respectively. In some cases, the controls 620, 630, and 640 may be twisted to select between different variables (e.g., variables that may correspond to the one or more controls associated with the audio mode described herein) of the one or more generated playlists at block 420. For example, rotating the control 620 to the right may change the selection from a novelty level to an energy level, and then to a lyricism level, and rotating the control 620 to the left may change the selection in the opposite order (e.g., from the novelty level to the lyricism level and then to energy level). In some cases, rotating the controls 620, 630, and 640 along tracks 650, 660, and 670 may control the magnitude of the variable being controlled. For example, control 620 may be configured to control a novelty of the one or more generated playlists at block 420, rotating the control 620 in a clockwise direction may increase the level of novelty of the one or more generated playlists at block 420, and rotating the control 620 in an anticlockwise direction may decrease the level of novelty of the one or more generated playlists at block 420. In certain aspects, the one or more controls 620, 630, 640 may each represent the one or more controls associated with one or more audio mode (e.g., one or more attribute controls associated with the Attributes mode 540, a control associated with the Curated mode 550, a spectrum control associated with the Background/Foreground mode 560, and/or a spectrum control associated with the Adventurous/Familiar mode 570).

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a "component," "circuit," "module" or "system." Furthermore, aspects of the present disclosure can take the form of a computer program product embodied in one or more computer readable medium(s) having computer readable program code embodied thereon.

As used herein, a phrase referring to "at least one of" or "one or more of" a list of items refers to any combination of those items, including single members. As an example, "at least one of: a, b, or c" is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read- only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program. For example, the computer readable storage medium can contain, for example, computer-executable instructions that, when executed by one or more processors of a device, individually or collectively, cause the device to perform the operations described herein.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. A system comprising:
a device of a user; and
one or more processors coupled to the device, the one or more processors, individually or collectively, being configured to:
select, in response to an initial action of the user, at least one audio mode; and
generate, for output on a speaker, one or more audio playlists based, at least in part, on at least one of a context of the device or one or more controls associated with the audio mode.

2. The system of claim 1, wherein the one or more processors, individually or collectively,
are configured to generate the one or more audio playlists by using a trained machine-learning model to generate at least one of a name for each of the one or more audio playlists or a seed song for each of the one or more audio playlists based, at least in part, on the context.

3. The system of claim 2, wherein the context includes at least one of a current time, a current day, an identity of the user, a schedule of the user, one or more favorite songs of the user, a listening history of the user, weather information, holiday information, or a connection of the device.

4. The system of claim 2, wherein the audio mode comprises an attribute mode, wherein the one or more controls comprise one or more attribute controls associated with the attribute mode, and wherein when the attribute mode is selected, the one or more processors, individually or collectively, are further configured to generate the one or more audio playlists based, at least in part, on the one or more attribute controls.

5. The system of claim 4, wherein the one or more attribute controls are each configured to be manipulated by the user to select an attribute and control a magnitude corresponding to the attribute, and wherein the attribute comprises an acousticness level, a danceability level, an energy level, an instrumentalness level, a liveness level, a speechiness level, a valence level, or a popularity level.

6. The system of claim 2, wherein the audio mode comprises a curated mode, and wherein when the curated mode is selected, the one or more processors, individually or collectively, are configured to generate the one or more audio playlists by using the name for each of the one or more audio playlists to search for a related audio playlist previously created by the user or provided by a music library.

7. The system of claim 2, wherein the audio mode comprises a background/foreground mode, wherein the one or more controls comprise a spectrum control associated with the background/foreground mode that ranges from a fully ambient level to a fully active level, and wherein when the background/foreground mode is selected, the one or more processors, individually or collectively, are further configured to generate the one or more audio playlists based, at least in part, on a level of the spectrum control.

8. The system of claim 2, wherein the audio mode comprises an adventurous/familiar mode,
wherein the one or more controls comprise a spectrum control associated with the adventurous/familiar mode that ranges from fully popular to fully user preferred, and wherein when the adventurous/familiar mode is selected, the one or more processors, individually or collectively, are further configured to generate the one or more audio playlists based, at least in part, on a level of the spectrum control.

9. The system of claim 1, wherein the audio mode comprises a current mode, and wherein when the current mode is selected, the one or more processors, individually or collectively, are configured to generate the one or more audio playlists based, at least in part, on at least one of a current song or a current artist of the current song of an audio playlist of the one or more audio playlists being output from the speaker.

10. The system of claim 1, wherein the one or more processors, individually or collectively, are further configured to:output, on the speaker, one of the one or more audio playlists; and
select the audio playlist of the one or more audio playlists output on the speaker based, at least in part, on one or more subsequent actions of the user, and wherein the one or more subsequent actions of the user comprise at least one of a speech vocalization of the user or a physical action of the user on the device.

11. The system of claim 1, wherein at least one of the one or more controls associated with the audio mode are at least periodically updated based, at least in part, on the context.

12. The system of claim 1, wherein the one or more processors, individually or collectively, are further configured to determine an identity of the user using a sensor during the initial action, and wherein the context is based, at least in part, on the identity of the user.

13. The system of claim 1, wherein:the device comprises a speaker system and the speaker is included in the speaker system;
or the speaker is included in a wearable device configured to be controlled by the one or more processors.

14. The system of claim 1, wherein the initial action of the user comprises at least one of a speech vocalization of the user or a physical action of the user on the device, and wherein the one or more processors, individually or collectively, are configured to select, in response to the initial action of the user, the audio mode by using a trained machine learning model to determine an intent of the user from the at least one of the speech vocalization of the user or the physical action of the user on the device.

15. A method comprising:selecting, in response to an initial action of a user of a device, at least one audio mode;
and generating, for output on a speaker, one or more audio playlists based, at least in part, on at least one of a context of the device or one or more controls associated with the audio mode.

16. The method of claim 15, wherein generating the one or more audio playlists comprises using a trained machine-learning model to generate at least one of a name for each of the one or more audio playlists or a seed song for each of the one or more audio playlists based, at least in part, on the context.

17. The method of claim 16, wherein the audio mode comprises an attribute mode, wherein the one or more controls comprise one or more attribute controls associated with the attribute mode, and wherein when the attribute mode is selected, the one or more audio playlists are based, at least in part, on the one or more attribute controls.

18. A non-transitory computer-readable medium comprising computer-executable instructions that, when executed by one or more processors of a device, cause the device to perform a method, the method comprising:selecting, in response to an initial action of a user of the device, at least one audio mode;
and generating, for output on a speaker, one or more audio playlists based, at least in part, on at least one of a context of the device or one or more controls associated with the audio mode.

19. The non-transitory computer-readable medium of claim 18, wherein generating the one or more audio playlists comprises using a trained machine-learning model to generate at least one of a name for each of the one or more audio playlists or a seed song for each of the one or more audio playlists based, at least in part, on the context.

20. The non-transitory computer-readable medium of claim 19, wherein the audio mode comprises an attribute mode, wherein the one or more controls comprise one or more attribute controls associated with the attribute mode, and wherein when the attribute mode is selected, the one or more audio playlists are based, at least in part, on the one or more attribute controls.
